(19) United States
(12) Patent Application Publication
(10) Pub. No.: US 2012/0312005 A1
(43) Pub. Date: Dec. 13, 2012

(54) Self-Pumping Hydropneumatic Piston-Cylinder Unit With Adjustable Level Position

(75) Inventors: Norbert ACKERMANN, Eitorf (DE); Holger Kirchner, Ruppichteroth (DE); Thomas Meyer, Siegburg (DE)

(73) Assignee: ZF Friedrichshafen AG, Friedrichshafen (DE)

(21) Appl. No.: 13/472,879

(22) Filed: May 16, 2012

(30) Foreign Application Priority Data
Jun. 9, 2011 (DE) 10 2011 077 267.7

(51) Int. Cl. F15B 1/02

(52) U.S. Cl. 60/413

(57) ABSTRACT

Self-pumping hydropneumatic piston-cylinder unit comprising a working cylinder in which a piston rod with a piston is guided so as to be axially movable, wherein the working cylinder carries a hollow pump rod aligned in the longitudinal axis of the piston-cylinder unit, wherein a radial control bore in the pump rod cooperates with a pump sleeve on the piston rod side, wherein the pump rod and the pump sleeve are connected to a fluid reservoir and form a pumping device by which a determined level position is automatically adjusted, wherein the pump sleeve is controllable by an actuator to adjust the determined level position, characterized in that the axial position of the pump sleeve relative to the control bore is adjustable by means of the actuator.

### BACKGROUND OF THE INVENTION

1. Field of the Invention

The present invention is directed to a self-pumping hydropneumatic piston-cylinder unit with adjustable level position.

2. Background of the Invention

DE 10 2004 009 224 B3 discloses a self-pumping hydropneumatic piston-cylinder unit of conventional construction in which a particular level position is predetermined by the constructional design. When this predetermined level position is departed from, the piston-cylinder unit carries out a pumping function in order, e.g., to raise or lower the vehicle body in that a high-pressure space and a low-pressure space are connected to one another during an extension movement via flow connections until the predetermined level position is reached again.

It is not possible to change the predetermined level position, e.g., on rough sections of road or during a high-speed phase.

EP 2 243 645 A1 discloses a self-pumping hydropneumatic piston-cylinder unit based on a piston-cylinder unit according to DE 10 2004 009 224 B3. However, in contrast to the latter, an adjusting function in level position is possible. For this purpose, the piston-cylinder unit has an actuator which rotates a sleeve inside the piston rod. The sleeve has a profiled end face in direction of the pump rod so that different effective lengths of the sleeve can be adjusted over the circumference of the sleeve. The effective length of the sleeve determines the desired level position.

This construction principle involves at least two drawbacks. All of the structural component parts used for the adjusting function must be adjusted so as to be rotationally oriented during assembly. For example, if the sleeve driven by the actuator is assembled so as to be turned slightly in circumferential direction, a different, incorrect level position will also occur.

It is pointed out in EP 2 243 645 A1 that a unit of the kind mentioned above can also be used at the front axle. When used at a steerable front axle, the sleeve in operative connection with the piston rod and a pump rod connected to the cylinder carry out a relative rotational movement which necessarily leads to an adjustment of the aimed-for level position of the piston-cylinder unit.

It is thus an object of the present invention to improve a self-pumping hydropneumatic piston-cylinder unit having adjustable level position in such a way that the above-mentioned drawbacks are overcome.

### SUMMARY OF THE INVENTION

According to the present invention, this object is met in that the axial position of the pump sleeve is adjustable relative to the control bore by means of the actuator.

The great advantage of the present invention is that the pump sleeve can have an end face extending at a right angle in the direction of the control bore. There is no need to ensure a particular alignment of the pump sleeve relative to the pump rod during assembly. Also, a relative rotational movement between the pump rod and pump sleeve would not affect the level position of the piston-cylinder unit.

In a first embodiment, the actuator is constructed as a rotary actuator and a rotational movement of the actuator is converted into an axial movement of the pump sleeve by a transmission.

The actuator is advantageously constructed as a hollow shaft motor which is fitted to the pump sleeve. The hollow shaft motor can be arranged in a housing so that, for example, a connection eye on the piston rod side can be fastened to the housing.

Alternatively, the actuator can be formed by a worm drive. In a worm drive, a self-locking effect can be used to fix a pump sleeve position.

In another embodiment, the actuator is formed by at least one axially acting actuating magnet. A transmission for the pump sleeve can be omitted.

A step for minimizing the actuating energy for the actuator consists in that the pump sleeve has a pressure compensation channel, wherein the axially acting pressure-loaded surfaces at the pump sleeve are dimensioned in such a way that the pump sleeve is axially pressure-balanced.

Further, it is possible that the pump sleeve is operatively connected to an adjusting piston which has a pressure-loaded actuating surface, and a control valve determines the supply of pressure medium to the adjusting piston. Pressure can be supplied from the piston-cylinder unit, i.e., no external energy is needed for the adjusting movement of the pump sleeve.

For operation of the adjusting piston, the pump space has a flow connection to the adjusting piston. Accordingly, only a small constructional expenditure is required for the flow connection.

In another advantageous embodiment, the pressure-loaded surface at the adjusting piston is larger than the pressure-loaded surfaces of the pump sleeve in the pump space and in a working space.

In order to enable the use of as many identical parts as possible with a conventional self-pumping piston-cylinder unit, the actuator is arranged in a housing fastened to the piston rod.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully with reference to the following drawings in which:

FIG. 1 is a cross-sectional view of general layout of the piston-cylinder unit with a hollow shaft motor;

FIG. 2 is a cross-sectional view of worm drive for the pump sleeve;

FIG. 3 is a cross-sectional view of spindle drive for the pump sleeve;

FIG. 4 is a cross-sectional view of electromagnetic actuator for the pump sleeve; and

FIG. 5 is a cross-sectional view of hydraulic actuator for the pump sleeve.

### DETAILED DESCRIPTION OF THE PRESENTLY PREFERRED EMBODIMENTS

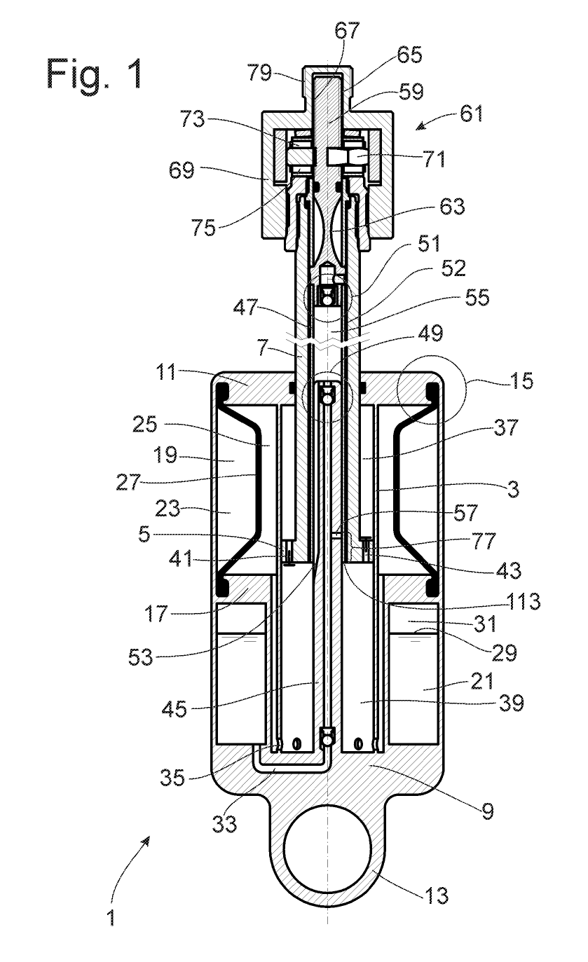

The self-pumping hydropneumatic piston-cylinder unit 1 for motor vehicles shown in FIG. 1 substantially comprises a working cylinder 3 in which a damping piston 5 slides at the end of a hollow piston rod 7. The working cylinder 3 is terminated on one side by an end wall 9 and on the other side by a rod guide 11 through which the hollow piston rod 7 passes outward in a sealed manner. The piston-cylinder unit 1 is fastened by the end wall 9 to an axle of the vehicle by a fastening eye 13, and the piston rod 7 is fastened to the body of the vehicle by means of another fastening eye, not shown. The working cylinder 3 is enclosed by an annular compensation chamber 15 which is filled partly with oil and partly with gas. This compensation chamber 15 is divided by an intermediate wall 17 into a high-pressure chamber 19 and a low-pressure chamber 21. A high-pressure gas cushion 23 in the high-pressure chamber 19 is separated from an oil space 25 by a dividing wall 27. An oil cushion 29 and a low-pressure gas cushion 31 are not separated from one another in the low-pressure chamber. In the fully controlled-down state, i.e., when not pumped up, the pressure in the low-pressure chamber 21 is the same as that in the high-pressure chamber 19.

The low-pressure chamber 21 and high-pressure chamber 19 are connected to the working cylinder by channels 33, 35. The working cylinder 3 is divided into two working spaces 37, 39 by the damping piston 5. In this connection, the damping piston 5 has damping valves 41, 43 for rebound and compression.

The level control of the self-pumping hydropneumatic piston-cylinder unit 1 is carried out by a pump rod 45 fastened on the cylinder side which forms a pump together with a pump sleeve 47 inside the piston rod 7. By means of an inlet valve 49 and an outlet valve 51, the axial relative movement of the pump rod 45 relative to the piston rod 7 and the pump sleeve 47 when the vehicle is in driving operation causes damping medium to be conveyed from the low-pressure chamber 21, through the inlet valve 49 and the outlet valve 51, then through the annular channel 52, into the working space 39 and oil space 25. In doing so, the pump sleeve 47 is moved outward until a bypass 53 produces a connection between a pump space 55 of the pump and the lower working space 39.

In case of a bypass connection, the pumping action of the pump is suppressed. An aimed-for level height of the vehicle is adjusted. When the load on the vehicle is removed, the pump sleeve 47 together with the piston rod 7 is pushed farther outward by the gas precharge pressure in the high-pressure chamber 19 until a pressure equilibrium comes about inside the piston-cylinder unit via a control bore 57 which is now open in the pump rod 45. Upon reaching this pressure equilibrium, the piston rod 7 moves inward with the damping piston 5.

The pump sleeve 47 has a drive portion 59 in operative connection with an actuator 61. There is a necked-down cross-sectional area 63 between the drive portion 59 and the pump sleeve 47 which brings about a certain radial elasticity between the pump sleeve 47 and the drive portion 59 in order to compensate if necessary for a radial offset between the pump sleeve 47 and the drive portion 59. The drive portion 59 has a motion thread 65 which engages in a corresponding mating thread 67 of a housing 69 fastened to the piston rod 7. Also arranged in the housing 69 is the actuator 61 which in this case is constructed as a rotary actuator in the constructional form of a hollow shaft motor. The hollow shaft motor, shown only schematically in FIG. 1, acts on a hollow shaft 71 having a motion thread. The hollow shaft 71 is fixed axially between bearing disks 73; 75 in the housing 69. In this way, the motion thread of the hollow shaft 71 and of the drive portion 59 of the pump sleeve 47 form a transmission which converts every rotational movement of the hollow shaft 71 into an axial movement of the pump sleeve 47 so that the axial position of the pump sleeve 47 is adjustable relative to the control bore 57 by means of the actuator 61. When the pump sleeve 47 is displaced axially in direction of the actuator 61, for example, an axial overlap 77 between the pump sleeve 47 and the control bore 57 is reduced and the aimed-for level position is lowered. With an opposite adjusting movement of the pump sleeve 47 in direction of the end wall 9 of the working cylinder 3, the overlap 77 is increased and the level position is raised.

Further, the housing 69 has a fastening portion for a connection member, not shown, e.g., a knuckle eye, at a supporting structural component part, e.g., a vehicle body.

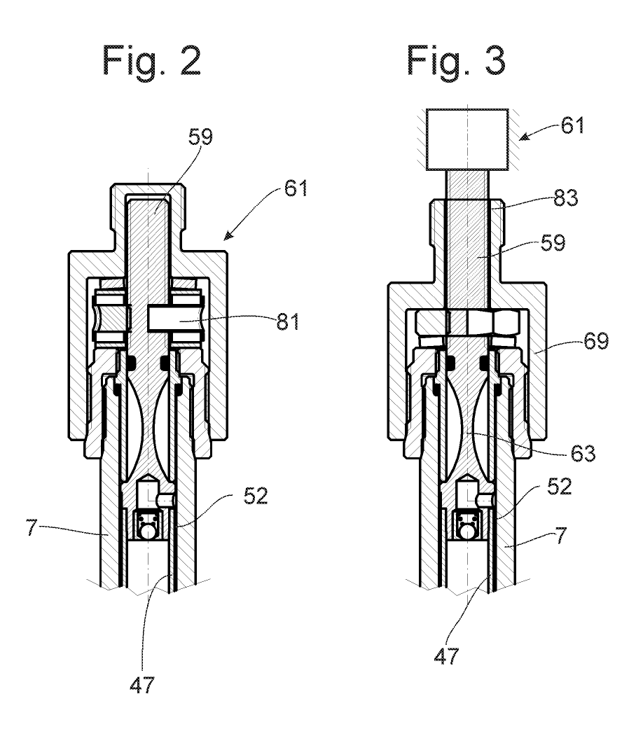

FIG. 2 shows an embodiment in which a worm drive is used as actuator instead of the hollow shaft motor. A worm wheel 81 driven by a worm shaft, not shown, is fastened to the drive portion 59 of the pump sleeve 47. The worm wheel/worm shaft connection ensures that the pump sleeve 47 is fixed in position axially without extra expenditure, since the worm drive is self-locking.

FIG. 3 shows that an ordinary spindle drive can also be used as actuator 61; the housing 69 has a through-opening 83 connecting to the drive portion 59. This solution is recommended particularly with a connection member in the form of a pin joint, which is well known.

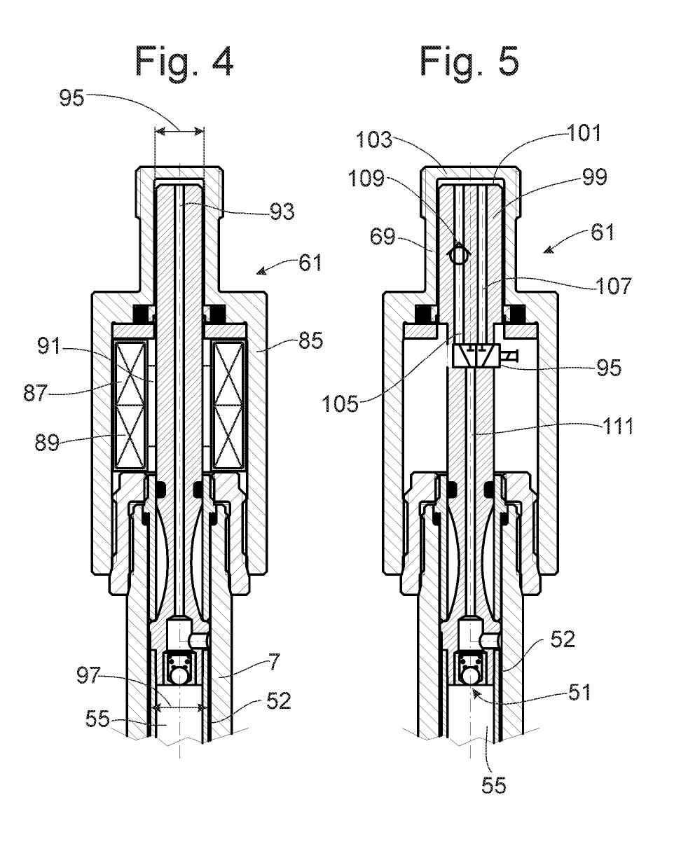

In FIG. 4, an axially acting actuating magnet 85 is used as actuator 61. In this embodiment, the actuating magnet 85 comprises two magnetic coils 87, 89, one magnetic coil for each movement direction of the pump sleeve 47. A magnet armature 91 is fitted to the pump sleeve 47 and transmits actuating forces to the pump sleeve 47 with the magnetic coils 87, 89. In order to minimize the actuating forces for the axial movement of the pump sleeve 47, the pump sleeve 47 has a pressure compensation channel 93. The axially acting pressure-loaded surfaces 95, 97 at the pump sleeve 47 are dimensioned in such a way that the pump sleeve 47 is axially pressure-balanced. The pressure compensation channel 93 is connected to the pump space 55.

FIG. 4 shows the pump sleeve 47 in an upper end position in which the pump sleeve 47 completely penetrates the magnetic coils 87, 89 axially and has an extra axial length for the stroke movement of the pump sleeve 47.

In FIG. 5, the actuator 61 does not exert any direct force on the pump sleeve 47; rather, it is a servo element in the form of a control valve 95. In this respect, the pump sleeve 47 is operatively connected to an adjusting piston 99 having at its end a pressure-loaded surface 101. The adjusting piston 99 is guided in the housing 69 so that the housing 69 forms an adjusting cylinder. The pressure-loaded surface 101 at the adjusting piston 99 in the adjusting cylinder 103 is constructed so as to be larger than the pressure-loaded surfaces of the pump sleeve 97 (FIG. 4) in the pump space 47 and in the working space 39. Two axial channels 105, 107 are formed in the adjusting cylinder 103, one axial channel 105 having a non-return valve 109 which closes in the direction of flow into the adjusting cylinder 103. The control valve 95 which is constructed in the manner of a 3/2 directional valve is arranged between a flow connection 111 in the pump sleeve 47 and the axial channels 105, 107. In a first switching position, the axial channel 105 with the non-return valve 109 is connected to the flow connection 111, and the other axial channel 107 is blocked. In a second switching position, the axial channel 105 with the non-return valve 109 is blocked and the other axial channel 107 is connected to the flow connection 111.

If the pump sleeve 47 is to be displaced axially in direction of the end wall 9 (FIG. 1) to aim for a higher level position, the control valve 95 is adjusted in such a way that axial channel 107 is hydraulically coupled and axial channel 105 with non-return valve 109 is blocked toward the flow connection 111. The pressure medium located in the pump space 47 flows via flow connection 111 into the adjusting cylinder 103 and, owing to the larger pressure-loaded surface 101 at the adjusting piston 99, displaces the pump sleeve 47 downward in direction of the end wall 9 so that the pump sleeve 47 has a longer axial overlap 77 proceeding from an end face 113 to the control bore 57. A longer overlap 77 (FIG. 1) results in the intended raising of the level position because the pumping phase is lengthened.

If the pump sleeve 47 is to be raised in the direction of the adjusting cylinder 103, i.e., if the overlap 77 is to be shortened, the flow connection 111 is connected via the control valve 95 to the axial channel 105 having the non-return valve 109. During a compression movement of the piston rod 7, the pressure medium cannot escape from the adjusting cylinder 103, but no pressure medium is supplied either. During a rebound movement of the piston rod 7, a negative pressure relative to the adjusting cylinder is formed in the working space 39 so that pressure medium is sucked out of the adjusting cylinder 103 via the open non-return valve 109 via the annular channel 52 into the working space 39. The adjusting piston 99 accordingly moves upward with the pump sleeve 47, i.e., the above-mentioned overlap 77 between the pump sleeve 47 and the control bore 57 is reduced. Consequently, the provided level position of the piston-cylinder unit 1 also drops.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A self-pumping hydropneumatic piston-cylinder unit comprising:
a working cylinder (3) having a working space (39);
a piston rod (7) including a piston (5) guided for axial movement within said working cylinder (3);
a hollow pump rod (45) within said working cylinder (3) aligned in a longitudinal axis of said piston-cylinder unit;
a pump sleeve (47) within said hollow pump rod (45);
said hollow pump rod (45) comprising a radially extending control bore (57) cooperating with said pump sleeve (47);
a fluid reservoir (21) connected to said pump rod (45) and said pump sleeve (47) so as to form a pumping device for automatically adjusting a predetermined level position; and
an actuator (61) for controlling the axial position of said pump sleeve (47) relative to said control bore (57).

2. The piston-cylinder unit according to claim 1, additionally comprising a transmission (85, 87, 81) and wherein said actuator (61) is constructed as a rotary actuator so that a rotational movement of said actuator (61) is converted into an axial movement of said pump sleeve (47) by said transmission (85, 87, 81).

3. The piston-cylinder unit according to claim 1, wherein said actuator (61) is constructed as a hollow shaft motor fitted to said pump sleeve (47).

4. The piston-cylinder unit according to claim 1, wherein said actuator (61) is formed by a worm drive.

5. The piston-cylinder unit according to claim 1, wherein said actuator (61) is formed by at least one axially acting actuating magnet (85).

6. The piston-cylinder unit according to claim 1, wherein said pump sleeve (47) additionally comprises a pressure compensation channel (93) and axially acting pressure-loaded surface (95, 97); and wherein said axially acting pressure-loaded surfaces (95, 97) at said pump sleeve (47) are dimensioned in such a way that said pump sleeve (47) is axially pressure-balanced.

7. The piston-cylinder unit according to claim 1, additionally comprising an adjusting piston (99) including a pressure-loaded actuating surface (101) and a control valve (95); said pump sleeve (47) operatively connected to said adjusting piston (99) and said control valve (95) constructed so as to determine the supply of pressure medium to said adjusting piston (99).

8. The piston-cylinder unit according to claim 7, additionally comprising a pump space (55) above said pump rod (45); said pump space (55) having a flow connection (111) to said adjusting piston (99).

9. The piston-cylinder unit according to claim 7, additionally comprising a pressure-loaded surface (97) in said pump space (55) and in said working space (39); and wherein said pressure-loaded surface (101) at said adjusting piston (99) is larger than said pressure-loaded surfaces (97) of said pump sleeve (47) in said pump space (55) and in said working space (39).

10. The piston-cylinder unit according to claim 1, additionally comprising a housing (69) fastened to said piston rod (7); and wherein said actuator (61) is arranged in said housing (69).
